(19) United States
(12) Patent Application Publication
(10) Pub. No.: US 2026/0140268 A1
(43) Pub. Date: May 21, 2026

(54) DETERMINING A SCATTERED RADIATION ESTIMATION FOR AN X-RAY BEAM DETECTOR

(71) Applicant: Siemens Healthineers AG, Forchheim (DE)

(72) Inventors: Julien ERATH, Erlangen (DE); Martin PETERSILKA, Adelsdorf (DE); Lukas HENNEMANN, Nuernberg (DE)

(73) Assignee: Siemens Healthineers AG, Forchheim (DE)

(21) Appl. No.: 19/389,372

(22) Filed: Nov. 14, 2025

(30) Foreign Application Priority Data
Nov. 15, 2024 (DE) 10 2024 211 001.9

(51) Int. Cl. G01T 1/164; G01T 1/166; G01T 7/00

(52) U.S. Cl. CPC G01T 1/1648; G01T 1/1663; G01T 7/005

(57) ABSTRACT

One or more example embodiments relates to a computer-implemented method for determining a scattered radiation estimation for an X-ray beam detector with detector elements, wherein an anti-scatter grid is in front of the X-ray beam detector, wherein in at least one direction, at least two respective detector elements are between respective adjacent lamellae of the anti-scatter grid.

### CROSS-REFERENCE TO RELATED APPLICATION(S)

The present application claims priority under 35 U.S.C. § 119 to German Patent Application No. 10 2024 211 001.9, filed Nov. 15, 2024, the entire contents of which are incorporated herein by reference.

### FIELD

One or more example embodiments relates to a computer-implemented method for determining a scattered ray (also referred to as scattered radiation) estimation for an X-ray beam detector with a plurality of detector elements, to a method for correcting scattered radiation effects in image data from an X-ray beam detector with a plurality of detector elements, to a corresponding computer program product or computer-readable storage medium and to a corresponding imaging device.

### RELATED ART

When X-ray radiation interacts with an object, for example a scanned object in a computed tomograph, scatter processes occur. For example, in the case of a computed tomography scan, the signal in the X-ray detector which is used can increase owing to the scattered radiation caused by the scatter processes, and this in turn results, as a rule, in image artifacts. One aim therefore is to reduce the influence of scattered radiation on the detector signal. In general, two different possibilities exist for correcting scattered radiation, which include, firstly, the minimization of the original development of scattered rays and, secondly, the correction of the scattered ray signal which has already been induced in the detector. To counteract the measurement of deflected radiation, a specific item of hardware can be used by employing a collimator or an anti-scatter grid.

In some cases, for example with photon-counting, the possibility of avoiding scattered radiation is limited, however. Owing to the smaller detector pixels, photon-counting detectors require coarse anti-scatter grids in which a plurality of pixels is accordingly situated between the lamellae of the anti-scatter grid. This can result in high frequencies in the otherwise low-frequency scattered radiation, whereby sharp ring-like artifacts can in turn develop in the reconstructed images. Secondly, an even finer structuring of the anti-scatter grid is often not desirable because the geometric efficiency can consequently be diminished. The geometric efficiency is a measure of the ratio of blocked area to permeable area of the photons. A diminished geometric efficiency means, in particular, that fewer quanta arrive in the detector. If the anti-scatter grid is more close-meshed, then fewer photons, which are to be associated with the actual signal, also pass (that is to say, for example, photons which pass directly through a patient) into the detector.

Empirical, physical or consistency-based models can be used for correcting the scattered radiation which has developed, see, for example, the publication: Ohnesorge B, Flohr T, Klingenbeck-Regn K. “Efficient object scatter correction algorithm for third and fourth generation CT scanners”, Eur Radiol. 1999; 9 (3): 563-9. doi: 10.1007/s003300050710. PMID: 10087134. An extensive description as well as a comparison of the correction options which are currently available for scattered radiation can be found in the references: Rührnschopf E P, Klingenbeck K. “A general framework and review of scatter correction methods in x-ray cone-beam computerized tomography. Part 1: Scatter compensation approaches”, Med Phys. 2011 July; 38 (7): 4296-311. doi: 10.1118/1.3599033. Erratum in: Med Phys. 2011 October; 38 (10): 5830. Erratum in: Med Phys. 2011 October; 38 (10): 5830. PMID: 21859031 as well as Rührnschopf E P, Klingenbeck K. “A general framework and review of scatter correction methods in cone beam CT. Part 2: scatter estimation approaches”, Med Phys. 2011 September; 38 (9): 5186-99. doi: 10.1118/1.3589140. PMID: 21978063. As an image-based approach, Monte Carlo simulations represent a gold standard for calculating the scatter ray signals and enable very precise determination of the scattered radiation. However, such methods are very computing-intensive and, as a rule, cannot therefore be executed in real time. Convolution-based scattered ray models represent a less time-intensive or computing-intensive alternative. In this case, the scattered radiation can be represented as a combination of the integrals of the source and the propagation of the scattering and are convolved with an estimated or measured scattered ray kernel. The source term describes the scattering which is derived from a simplified model (for example, only scattering of the first order along the primary radiation is taken into account). By contrast, the propagation term reproduces the local scattering of the photons. By multiplying these two variables it is possible to determine the scattered ray distribution for an individual X-ray beam which can be completed by the integration of all X-ray beams.

### SUMMARY

While such convolution-based scattered ray models have a relatively low computing intensity, they often reach their limits precisely in the case of scattered ray determination in photon-counting detectors and/or in static computed tomography systems, so scattered ray artifacts, at least in some cases, cannot be adequately or satisfactorily eliminated.

One or more example embodiments performs scattered ray estimation and/or scattered ray correction, which is not very computing-intensive, such as in real time, and is simultaneously as accurate as possible.

This object is achieved by a method as claimed in claim 1, a method as claimed in claim 8, a computer program product or computer-readable storage medium as claimed in claim 9 and an imaging device as claimed in claim 10. Further features and advantages can be found in the dependent claims, the description and the accompanying figures. Independent of the grammatical term usage, individuals with male, female or other gender identities are included within the term.

### BRIEF DESCRIPTION OF THE DRAWINGS

Embodiments will be described below with reference to the attached figures.

FIG. 1 shows a flowchart of a computer-implemented method for determining a scattered ray estimation according to one embodiment of the invention,

FIG. 2 schematically shows the principle of an X-ray beam detector with exactly one respective detector element between adjacent lamellae of an anti-scatter grid,

FIG. 3 schematically shows an inventive principle of an X-ray beam detector with a plurality of respective detector elements between adjacent lamellae of an anti-scatter grid according to one or more example embodiments,

FIG. 4 shows one example of an inventive X-ray beam detector, in front of which an anti-scatter grid with a plurality of lamellae is arranged,

FIG. 5 shows the arrival of X-ray beams on the detector elements between two adjacent lamellae of an inventive X-ray beam detector according to one or more example embodiments,

FIG. 6 shows a measurement of an anthropomorphic thorax phantom on a computed tomography device with an energy-integrating X-ray beam detector according to one or more example embodiments,

FIG. 7 shows a measurement of the anthropomorphic thorax phantom on a computed tomography device with a photon-counting X-ray beam detector according to one or more example embodiments,

FIG. 8 schematically shows an arrangement of lamellae of an anti-scatter grid in front of an X-ray beam detector according to one embodiment of the invention,

FIG. 9 shows detector data of a central 30 cm water phantom in the log space,

FIG. 10 shows the principle of the division of detector data from a detector corresponding to the X-ray beam detector shown in FIG. 8 according to one embodiment of the invention,

FIG. 11 shows a scattered ray distribution of a central 30 cm water phantom on the basis of two scattered ray terms from inventively divided detector data,

FIG. 12 shows a symmetrical convolutional kernel for convolution in the phi-direction according to the prior art,

FIG. 13 shows two asymmetrical convolutional kernels for convolution in the phi-direction according to one embodiment of the invention,

FIG. 14 shows a scattered ray distribution of a central 30 cm water phantom for a convolved scattered ray term of the left-hand group in FIG. 10 according to one embodiment of the invention together with a scattered ray distribution on the basis of a Monte Carlo simulation and a scattered ray distribution according to the prior art,

FIG. 15 shows a scattered ray distribution of a central 30 cm water phantom for a convolved scattered ray term of the right-hand group in FIG. 10 according to one embodiment of the invention together with a scattered ray distribution on the basis of a Monte Carlo simulation and a scattered ray distribution according to the prior art,

FIG. 16 shows a merged scattered ray estimation for a central 30 cm water phantom in the form of a scattered ray distribution according to one embodiment of the invention together with a scattered ray distribution on the basis of a Monte Carlo simulation and a scattered ray distribution according to the prior art,

FIG. 17 shows a flowchart of a method for correcting scattered radiation effects in image data from an X-ray beam detector with a plurality of detector elements and with an anti-scatter grid in front of the X-ray beam detector according to one embodiment of the invention,

FIG. 18 shows the influence of radio-frequency scattered ray effects without a scattered ray correction in illustrative image data,

FIG. 19 shows the influence of radio-frequency scattered ray effects with a scattered ray correction according to the prior art in illustrative image data,

FIG. 20 shows the influence of radio-frequency scattered ray effects with a scattered ray correction according to a method as described in FIG. 1 in illustrative image data,

FIG. 21 shows detector data of a decentral 30 cm water phantom in the log space,

FIG. 22 shows a scattered ray distribution of a decentral 30 cm water phantom on the basis of two scattered ray terms from inventively divided detector data,

FIG. 23 shows a scattered ray distribution of a decentral 30 cm water phantom for a convolved scattered ray term of the left-hand group in FIG. 10 according to one embodiment of the invention together with a scattered ray distribution on the basis of a Monte Carlo simulation and a scattered ray distribution according to the prior art,

FIG. 24 shows a scattered ray distribution of a decentral 30 cm water phantom for a convolved scattered ray term of the right-hand group in FIG. 10 according to one embodiment of the invention together with a scattered ray distribution on the basis of a Monte Carlo simulation and a scattered ray distribution according to the prior art,

FIG. 25 shows a merged scattered ray estimation for a decentral 30 cm water phantom in the form of a scattered ray distribution according to one embodiment of the invention together with a scattered ray distribution on the basis of a Monte Carlo simulation and a scattered ray distribution according to the prior art, and

FIG. 26 shows an imaging device based on X-ray beams according to one embodiment of the invention.

### DETAILED DESCRIPTION

According to one or more example embodiments, a computer-implemented method for determining a scattered ray estimation for an X-ray beam detector with a plurality of detector elements is provided, wherein an anti-scatter grid is arranged in front of the X-ray beam detector. In particular, the X-ray beam detector can be part of a computed tomography system. In at least one direction, at least two respective detector elements are arranged between respective adjacent lamellae of the anti-scatter grid, in particular at different positions relative to the nearest respective lamella of the anti-scatter grid, wherein the method comprises the following steps:
receiving detector data and dividing the detector data into at least two groups of detector data on the basis of the position of the detector elements, from which the detector data respectively originates, relative to the respective nearest lamella of the anti-scatter grid;
determining a scattered ray distribution which estimates a scattering on the basis of the detector data, in the form of a scattered ray term for each of the groups of detector data;
convolving the scattered ray term of each of the groups with a respective convolutional kernel individually adjusted for each group, so a plurality of convolved scattered ray terms corresponding to the number of groups is generated;
merging the scattered ray distributions according to the convolved scattered ray terms corresponding to the position of the detector elements in order to thus obtain a scattered ray estimation.

Advantageously, the inventive method also explicitly takes into account the geometry of the anti-scatter grid in that the detector data is divided into at least two corresponding groups. Consequently, the scattered ray estimation can be used for a scattered ray correction, with it being possible to avoid artifacts. In particular, radio-frequency artifacts, for example ring artifacts or partial ring artifacts, which often occur without the division, can be avoided or at least significantly attenuated. It has been found that, to some extent, considerable differences can exist in the intensity of the scattered radiation between adjacent detector elements, which, due to reciprocal occurrence (detector elements to the left and right of a lamella respectively), can result in the radio-frequency frequencies. The differences in the intensity can advantageously also be incorporated by this method. The method enables correct correction of the scattered radiation in the beginning. Consequently, certain frequencies no longer have to subsequently be suppressed in the image space in order to attenuate the artifacts. It has been found that the clinical diagnosis is adequately provided even when a sharp reconstruction kernel is used. A sharp reconstruction kernel emphasizes the edges more, whereas a soft reconstruction kernel results in amplified smoothing. As radio-frequency artifacts are avoided from the outset with this method, edges with an identical frequency accordingly do not have to be suppressed in the image construction here either if the radio-frequency artifacts do not have to be attenuated subsequently.

An X-ray beam detector is generally a detector which is suitable for detecting X-ray radiation. It can also be referred to as an “X-ray detector” or simply a “detector” for short. In particular, the X-ray beam detector is embodied to detect an X-ray beam intensity and/or dose. The X-ray beam detector can be, in particular, an X-ray beam detector of a computed tomography system, a radiography device or a C-arm. The X-ray beam detector comprises a plurality of detector elements. The detector elements can also be referred to as detector pixels. For example, the detector elements can comprise an X-ray-sensitive material which is embodied to detect the X-ray radiation. For example, detector elements can comprise a scintillation material and/or a scintillation counter for detecting the X-ray radiation. The scintillation material can be embodied to convert X-ray radiation into light, in particular visible light. The X-ray beam detector can be, in particular, a photon-counting X-ray detector. A photon-counting X-ray detector is generally designed to detect individual X-ray photons, in particular broken down in terms of location and/or time, and to count them. Typically, a photon-counting X-ray detector comprises an X-ray converter in which incident X-ray beams or X-ray photons generate moving charge carriers, in particular electron-hole pairs, which are used for reading out the signal. The X-ray beam detector can be, for example, a flat panel detector or flat image detector.

A scattered ray estimation, which can also be referred to as a scattered ray estimate within the context of the invention, is generally an estimate of the scattered rays arriving in an X-ray beam detector. In an object to be examined using X-ray radiation, typically some of the photons are absorbed whereas a further portion is scattered in one or more scatter process(es). Scattered photons, which strike the X-ray beam detector, add up to form the actual signal; they therefore increase the detector signal and typically result in image artifacts. A scattered ray estimation can therefore be used to subtract the scattered radiation from the total signal in order to thus obtain the actual measuring signal.

An anti-scatter grid is generally an apparatus which is arranged in front of the X-ray beam detector and is embodied to reduce an incidence of scattered radiation on the X-ray beam detector. The anti-scatter grid comprises lamellae for this purpose. The lamellae are preferably arranged substantially parallel to one another in at least one direction. The lamellae can be arranged in front of the X-ray beam detector as a rectangular grid, in particular with groups of lamellae running parallel to one another in two directions respectively. Directions of the anti-scatter grid can be differentiated in the row direction and the column direction. The row direction and the column direction are the directions in which the detector elements are arranged. The row direction is the direction in which the rows of the anti-scatter grid run. The column direction is the direction in which the columns of the anti-scatter grid run. The row direction can correspond, in particular, to a z-direction of the measuring device being used, in particular a computed tomography device. With a computed tomography device or a measuring device with a gantry or an examination tunnel, the z-direction is, in particular, an axial direction. The column direction can correspond, in particular, to a phi-direction or o-direction of the measuring device being used, in particular a computed tomography device. The phi-direction or o-direction is, in particular, a circumferential direction in which an X-ray beam detector is arranged or a circumferential direction, for example of a gantry. In general, the phi-direction or o-direction is a direction substantially perpendicular to the z-direction. At least respective two detector elements are arranged between respective adjacent lamellae of the anti-scatter grid in at least one direction. In other words, a plurality of respective detector elements is situated between the lamellae. This arrangement can be advantageous precisely with small detector elements, such as in the case of photon-counting detectors, to be able to receive a still-adequate quantity of signal. Because more than one detector element is arranged between the lamellae, in many cases each detector element receives a different portion of the scattered radiation. For example, a left-hand detector element can be closer to a left-hand lamella and can therefore potentially receive less scattered radiation coming from the left than a right-hand detector element which is situated further away from the left-hand lamella.

The received detector data can be provided or sent, for example, from a database or directly from the X-ray beam detector. The detector data is divided into at least two groups of detector data. For example, the detector data can be divided into a first group and a second group. With a division into two different groups, each of the groups can comprise, in particular, detector data which corresponds to half the quantity of the original detector data. However, more than two groups can also be provided. The detector data is divided on the basis of the position of the detector elements from which the detector data respectively originates. The position is, in particular, the position relative to the nearest respective lamella of the anti-scatter grid. The detector data can be divided, in particular, alternatingly corresponding to its position. For example, detector data from detector elements, which have a lamella of the anti-scatter grid immediately to their left-hand side, can be divided into a first group and detector data from detector elements, which have a lamella of the anti-scatter grid immediately to their right-hand side, can be divided into a second group. Detector elements, to the left or right side of which there is a further detector element before the next lamella, can in this sense be understood such that they do not have a lamella of the anti-scatter grid immediately to their left-hand or right-hand side. If, for example, more than two detector elements are arranged between the lamellae of the anti-scatter grid, optionally more than two different groups could also be provided. However, a division into only two groups can also already be advantageous with more than two detector elements between the lamellae. For example, a group can be provided for each relative positioning of detector elements relative to the respective next lamellae of the anti-scatter grid.

A scattered ray distribution in the form of a scattered ray term is determined for each of the groups on the basis of the detector data. The scattered ray distribution can be, in particular, a distribution of the scattered ray intensities over the detector elements. The scattered ray terms of both groups can optionally be similar or substantially identical to one another. The scatter term of the respective group is determined, in particular, with the measured intensity data of the respective group. The scattered ray term of each of the groups is convolved with a convolutional kernel individually adjusted respectively for each group. In particular, the convolutional kernels are different for at least two of the groups, preferably (with more than two groups) different for each of the groups. The convolutional kernels can be adjusted, in particular, depending on the geometry respectively of the anti-scatter grid and/or the position of the detector elements of the group relative to the lamellae. For example, the convolutional kernel can be based on a triangular shape which is or was adjusted corresponding to the geometry. For example, a side length of the triangular shape can be adjusted. For example, a height and at least one edge and/or width of the convolutional kernel, in particular of the triangular shape, can be adjusted. It can optionally be provided that a plurality of convolutions is carried out for each of the groups, for example a first time for a first direction (for example, the phi-direction or column direction) of the anti-scatter grid and a further time for a second direction (for example, the z-direction or the row direction) of the anti-scatter grid. A plurality of convolved scattered ray terms-corresponding to the number of groups—is generated by convolving the scattered ray terms with the convolutional kernels. In particular, a kernel-based scattered ray estimation with adjusted convolutional kernels is thus provided. Advantageously, by adjusting the convolutional kernels, in particular a radio-frequency portion of the scattered radiation resulting from the geometry of the anti-scatter grid can.

The scattered ray distributions according to the convolved scattered ray terms are merged corresponding to the position of the detector elements. In particular, the convolved scattered ray terms can be alternatingly merged corresponding to the position of detector elements. The scattered ray estimation thus obtained is, in particular, a total scattered ray distribution across all detector elements. In particular, the intensity values of the total scattered ray distributions can be arranged or distributed according to the positions of the detector elements.

According to one embodiment, the scattered ray term comprises a source term which is based on a scattered ray model from scattered ray sources, and a propagation term which estimates local photon scattering of the scattered rays. One possibility for calculating source term and propagation term is described, for example, in Ohnesorge B, Flohr T, Klingenbeck-Regn K. “Efficient object scatter correction algorithm for third and fourth generation CT scanners”, Eur Radiol. 1999; 9 (3): 563-9. doi: 10.1007/s003300050710. PMID: 10087134 and can optionally be analogously adopted here. The source term can describe, for example, a scattering which is derived from a simplified model. A model can, for example, be simplified in such a way that the scattering of the first order along the primary radiation is taken into account. In particular, it can be provided that for the scattered ray term, the source term and the propagation term are multiplied by one another. For example, a scattered ray term pep can be of the form

$$pep = {p}_{source ,} \cdot {e}^{- κ \cdot p propagation}$$

where p_{source} is the source term and e^{-κ·p}^{_{propagation}} is the propagation term and k is a constant. The source term can be determined, in particular, from the intensity of the signal with a logarithm, for example in the form p_{source}=−log (I/I₀). It can be provided that the two terms or the scattered ray term are integrated, in particular for all X-ray beams of a measurement. In particular, a multiplication of source term and propagation term can describe a scattered ray distribution for an individual X-ray beam, which can be completed by the integration of all X-ray beams. The use of source term and propagation term represents a particularly favorable, that is to say, in particular, less computing-intensive, possibility for determining scattered radiation.

According to one embodiment, at least one of the convolutional kernels is asymmetrically embodied. In particular, at least two of the convolutional kernels are asymmetrically embodied. For example, the at least one convolutional kernel can be an asymmetrical triangle, in particular with different legs, preferably different left and right legs. The asymmetry of the convolutional kernel can correspond, in particular, to the asymmetry of the geometry of the respective detector elements relative to the anti-scatter grid and/or be based thereon. For example, a degree of asymmetry can be set on the basis of the distance from the anti-scatter grid at the sides of the detector element. Previously it has been customary in the prior art, by contrast, to use a standardized symmetrical triangular convolutional kernel. The asymmetry of the underlying problem can advantageously be taken into account more precisely by the asymmetric embodiment of the convolutional kernel. A convolution (*) with the respective convolutional kernel (h_{right/left}) can be provided according, for example, to the following formula

$${I}_{S , right / left} = ( γ . {p}_{source , right / left} \cdot {e}^{- κ \cdot {p}_{p r o p a g a t ion , righ t / left}} ) * {h}_{r ight / left}$$

where I_{S} is the estimated scattered ray intensity or the scattered ray estimation, γ and κ are constants and h is the convolutional kernel.

According to one embodiment, the number of groups of detector data, into which the detector data is divided, corresponds to the number of detector elements between adjacent lamellae respectively of the anti-scatter grid. In other words, it can be provided that the detector data is divided into as many sub-detector data as there are detector elements between the lamellae respectively, with the sub-detector data respectively only detector data which originates from one type of detector element positions relative to the lamellae. Advantageously, the geometry of the X-ray beam detector and the anti-scatter grid can be taken into account particularly effectively and exactly with this division.

According to one embodiment, the detector data is divided into groups of detector data in such a way that at least one of the groups originates from detector elements which differ with regard to their position relative to the lamellae in the phi-direction from the detector elements of at least one other group. The phi-direction can correspond, in particular, to a column direction of the anti-scatter grid. The phi-direction can preferably be the direction in whose direction more detector elements are provided than in a further direction of the anti-scatter grid, namely, in particular the z-direction. Advantageously, a geometric inequality of the detector elements relative to the anti-scatter grid can thus be compensated. It has been found that significant improvements in the scattered ray estimate can be achieved with this measure.

According to one embodiment, the detector data is divided into, in particular at least four, groups of detector data in such a way that at least one of the groups originates from detector elements which differ with regard to their position relative to the lamellae in the phi-direction from the detector elements of at least one other group, and/or that at least one of the groups originates from detector elements which differ with regard to their position relative to the lamellae in the z-direction from the detector elements of at least one other group. The groups, which differ with regard to the z- and phi-directions of their detector elements can be the same two groups and/or different pairs of groups. For example, the detector data can be divided into groups of detector data in such a way that at least one of the groups originates from detector elements which differ with regard to their position relative to the lamellae in the phi-direction and in the z-direction from the detector elements of at least one other group. For example, the detector data can be divided into groups of detector data in such a way that a first of the groups originates from detector elements which differ with regard to their position relative to the lamellae in the phi-direction from the detector elements of at least one second group, and/or that a third of the groups originates from detector elements which differ with regard to their position relative to the lamellae in the z-direction from the detector elements of at least one fourth group. For example, the detector data can be divided into groups of detector data in such a way that a first of the groups originates from detector elements which differ with regard to their position relative to the lamellae in the phi-direction from the detector elements of at least one second group and which differ with regard to their position relative to the lamellae in the z-direction from the detector elements of at least one third group. Advantageously, it is thus possible to take into account when a plurality of detector elements is arranged between two adjacent lamellae each both in the phi-direction and in the z-direction. It is thereby possible to achieve a particularly precise scattered ray estimation. The phi-direction can correspond, in particular, to a column direction and the z-direction can correspond, in particular, to a row direction of the anti-scatter grid. Preferably, more detector elements can be provided in the phi-direction than in the z-direction. It can be provided that the number of groups, into which the data is divided, corresponds to the number which results when the number of detector elements between adjacent lamellae in the phi-direction is multiplied by the number of detector elements between adjacent lamellae in the z-direction. In particular, the groups of detector data can be divided such that each of the groups originates from detector elements which are different with regard to their relative position from the detector elements from which the other groups originate. In this sense, different means that the relative position to the lamellae in the phi-direction and/or the relative position to the lamellae in the z-direction is different. It can be provided that two convolutions, in particular one convolution each in the phi-direction and one convolution in the z-direction, are carried out for each of the groups.

According to one embodiment, the convolutional kernels are adjusted respectively on the basis of a precise simulation, in particular a Monte Carlo simulation, or a measurement of the scattered radiation. For example, the convolutional kernels can be adjusted by a fitting and/or optimization method to the simulation or to the measurement. The adjusting can have been carried out, in particular, in advance of the actual method. For example, an adjustment can be carried out for a specific imaging device and then used for subsequent applications of this method. Advantageously, the accuracy of a simulation can thus be utilized more or less as a calibration, although the (time-consuming) simulation does not have to be carried out again and again. The simulation and/or the measurement of the scattered radiation can be based, for example, on a defined (theoretical or actual) phantom. For example, a specific phantom as the simulated measurement object can be assumed for the precise simulation. The scattered ray term or the scattered ray terms can then be determined for the groups and the convolutional kernels adjusted for this simulated measurement object such that a scattered ray estimate results which corresponds as accurately as possible to the scattered ray estimate of the precise simulation. Accordingly, it is possible to proceed with a real phantom and measurement data with this phantom. As a phantom is accurately defined, a scattered ray portion of the phantom can be directly ascertained more easily in the case of a measurement with the phantom. The precise simulation can be based, for example, on a statistical approach or an analytical approach.

The precise measurement can be based, for example, on a Monte Carlo simulation. A Monte Carlo simulation is a statistical approach. With a Monte Carlo simulation, a scattered ray estimation can advantageously be calculated very precisely. In particular, the Monte Carlo simulation can be adjusted to the respectively used X-ray beam detector. The use of a Monte Carlo simulation for scattered ray estimation is known per se in the prior art and is described, for example, in Rührnschopf E.-P. and Klingenbeck K. “A general framework and review of scatter correction methods in x-ray cone-beam computerized tomography. Part 1: Scatter compensation approaches”, Med Phys. 2011 July; 38 (7): 4296-311. doi: 10.1118/1.3599033. Erratum in: Med Phys. 2011 October; 38 (10): 5830. Erratum in: Med Phys. 2011 October; 38 (10): 5830. PMID: 21859031 as well as in Rührnschopf, E.-P. and Klingenbeck, K., “A general framework and review of scatter correction methods in cone beam CT. Part 2: scatter estimation approaches”. Med Phys. 2011 September; 38 (9): 5186-99. doi: 10.1118/1.3589140. PMID: 21978063. Due to the relatively long duration of such calculations, however, it is advantageous if this calculation is carried out in advance only in a calibration step, and then, in particular in daily use, the inventive method is applied. An optimization function can be used for adjustment to a Monte Carlo simulation. The optimization function can be used to adjust an error in the image space caused by scattered radiation. The error in the image space can be described by a ratio of scattered radiation to primary signal (“scatter-to-primary”), so a large ratio corresponds to a large error. The error can be calculated and adjusted correspondingly for each channel of the X-ray beam detector. It can be provided that the adjustment is also verified once again in the framework of a calibration by a test measurement in the image space. For example, a Scatter-to-Primary Mean Absolute Percentage Error (SPMAPE) can be used for the optimization of the convolution parameter. The scatter-to-primary ratio correlates directly with the error in the reconstructed image. With detector pixels or detector elements where the primary signal is low, scattered photons can result in a large image error. As a result it is particularly important to correct these positions with a high scatter-to-primary ratio. The optimization can be carried out with the aid of a cost function. The cost function can be described, for example, by the following formula:

$${l}_{S P M A P E} = \frac{100}{N} \sum \vert \frac{{I}_{Scatter , P r e diction} - {I}_{Scatter , G T}}{{I}_{P r i m a r y}} \vert$$

where I_{Scatter, Prediction} is the estimated scattered ray intensity due to the convolution approach, I_{Scatter,GT} is the scattered ray intensity due to the Monte Carlo simulation and I_{Primary} is the primary ray intensity due to the Monte Carlo simulation. The parameter N corresponds to the number of detector pixels or detector elements and it is added up, in particular, for the number N. An analytical approach can be based, for example, on a Boltzmann transport equation.

One or more example embodiments is a method for correcting scattered radiation effects in image data from an X-ray beam detector with a plurality of detector elements, wherein an anti-scatter grid is arranged in front of the X-ray beam detector, wherein in at least one direction, at least two detector elements respectively are arranged between adjacent lamellae respectively of the anti-scatter grid, wherein the method comprises the steps of the method for determining a scattered ray estimation as described herein as well as at least the following step: correcting the image data on the basis of the scattered ray estimation. All advantages and features of the method for determining a scattered ray estimation can be transferred analogously to the method for correcting scattered radiation effects, and vice versa. In particular the scattered ray estimation is offset against the detector data in order to correct the image data. For example, the scattered ray estimation can be deducted from the intensity signal of the detector data in order to obtain a scattered ray-corrected intensity signal of the detector data.

One or more example embodiments is a computer program product or computer-readable storage medium, comprising commands which when executed by a computer and/or an evaluation apparatus prompt it to execute the steps of one of the methods as described herein. All advantages and features of the method for determining a scattered ray estimation and the method for correcting scattered radiation effects can be transferred analogously to the computer program product or the computer-readable storage medium, and vice versa. The storage medium can be, for example, a hard disk, an SSD, a flash memory, an online server, etc.

One or more example embodiments is an imaging device based on X-ray beams, in particular a medical imaging device, comprising an X-ray beam source, an X-ray beam detector with a plurality of detector elements, an anti-scatter grid with lamellae, which is arranged in front of the X-ray beam detector, wherein in at least one direction of the anti-scatter grid, at least two respective detector elements are arranged between respective adjacent lamellae of the anti-scatter grid, and an evaluation apparatus which is configured to receive detector data from the X-ray beam detector and to execute one of the methods as described herein. All advantages and features of the method for determining a scattered ray estimation, of the method for correcting scattered radiation effects and of the computer program product or computer-readable storage medium can be transferred analogously to the imaging device, and vice versa. An appropriate wireless and/or wired connection between the X-ray beam detector and the evaluation apparatus can be provided for receiving the detector data by way of the evaluation apparatus. The evaluation apparatus can have an interface for receiving the detector data. The X-ray beam detector can have an interface for sending the detector data. The imaging device can be, in particular, a computed tomography device, a C-arm device or a radiography device for conventional X-ray imaging. The anti-scatter grid can comprise a two-dimensional grid or grating made of lamellae. It can be provided that a plurality of detector elements is arranged between the lamellae of the anti-scatter grid in two directions of the anti-scatter grid. For example, in a first direction (for example phi-direction), at least two detector elements can be arranged between two adjacent lamellae and in a second direction (for example z-direction), at least two, in particular at least three, detector elements can be arranged between two adjacent lamellae. The anti-scatter grid and the X-ray beam detector can be embodied, in particular in their structure and/or their relative arrangement to one another or, generally, in their properties, as described herein with reference to an anti-scatter grid and/or an X-ray beam detector. The term X-ray beam source should be broadly interpreted in the framework of this invention. It relates, in general, to a device which is suitable for generating X-ray beams. X-ray beam source can also be referred to as an X-ray source. The X-ray beams can be embodied, for example, in a fan shape. The X-ray source can comprise, for example, at least one X-ray tube for generating the X-ray beams. The X-ray source can optionally comprise a plurality of X-ray tubes.

All embodiments described herein can be combined with one another unless explicitly stated otherwise.

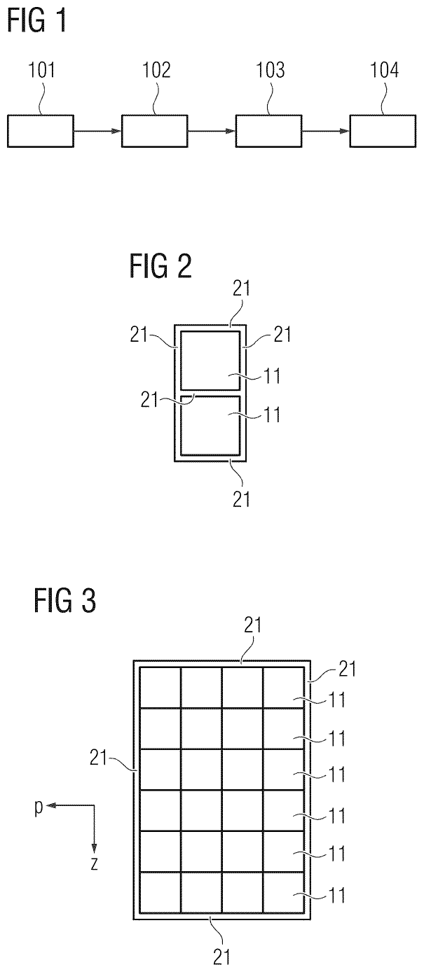

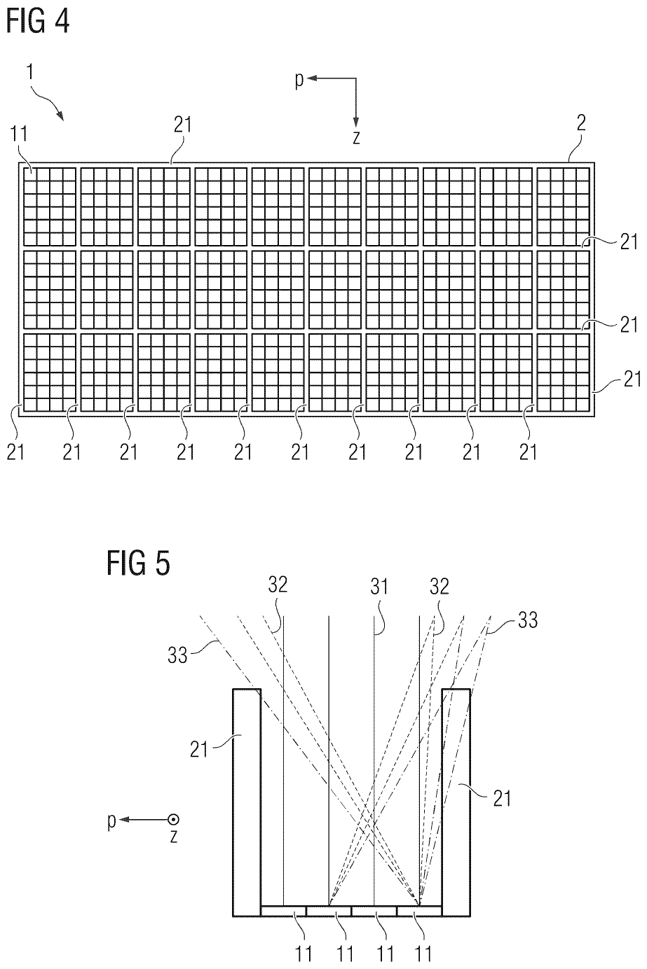

FIG. 1 shows a flowchart of a computer-implemented method for determining a scattered ray estimation according to one embodiment of the invention. The scattered ray estimation is carried out for an X-ray beam detector 1 with a plurality of detector elements 11. An anti-scatter grid 2 is provided in front of the X-ray beam detector 1. At least two respective detector elements 11 are arranged between respective adjacent lamellae 21 of the anti-scatter grid 2 in at least one direction. This concept of an anti-scatter grid 2 is illustrated on the basis of FIGS. 2 and 3. FIG. 2 schematically shows the principle of an X-ray beam detector 1 with exactly one respective detector element 11 between adjacent lamellae 21 of an anti-scatter grid 2. Representatively shown are two detector elements 11, which are surrounded on each side respectively by lamellae 21. Such a detector form is typically used in energy-integrating X-ray beam detectors 1. FIG. 3 schematically shows, by contrast, the inventive principle of an X-ray beam detector 1 with a plurality of respective detector elements 11 between adjacent lamellae 21 of an anti-scatter grid 2. Such a detector form is often used, for example, preferably in photon-counting X-ray beam detectors 1. In this example there is a plurality of respective detector elements 11 between the adjacent lamellae 21 in the phi-direction p (four detector elements 11) as well as in the z-direction z (six detector elements 11). FIG. 4 shows an example of an inventive X-ray beam detector 1, in front of which an anti-scatter grid 2 with a plurality of lamellae 21 is arranged, between which, according to the principle in FIG. 3, a plurality of respective detector elements 11 is provided in the phi-direction p as well as in the z-direction z. FIG. 5 illustrates the arrival of X-ray beams 31, 32, 33 onto the detector elements 11 between two adjacent lamellae 21. X-ray signal beams 31 which are currently striking are not blocked by the lamellae 21 here and strike the detector elements directly. Some scattered rays 33 are blocked by the lamellae 21 of the anti-scatter grid 2, However, further scattered rays 32 strike the detector elements 11. However, there are differences with regard to the incoming scattered rays 32 depending on whether the detector elements 11 to the left or right in the phi-direction are arranged immediately next to one of the lamellae 21 or are arranged further away from the next lamella 21. More scattered rays 32 from a respective side tend to strike a detector element 11 the further the detector element 11 on this side is arranged from the next lamella 21. Depending on the position of the detector elements 11, a difference thus results in the scattered ray intensity for the various detector elements 11, in particular also for adjacent detector elements. If this difference is not taken into account, as is currently customary in the prior art, then artifacts can result when the incoming scattered rays 32 are calculated.

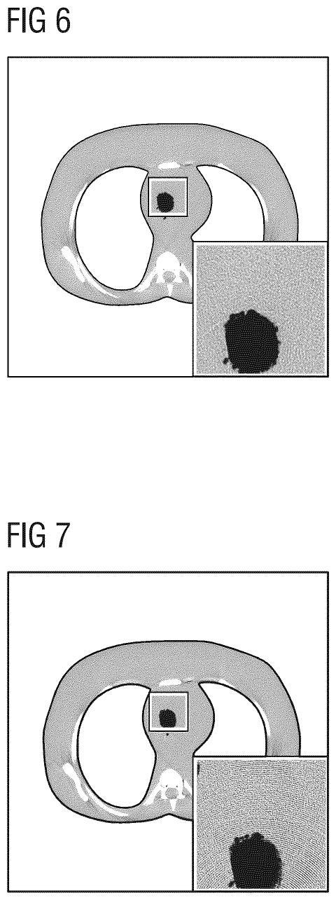

FIGS. 6 and 7 serve to illustrate the effect which can result due to a plurality of detector elements 11 between adjacent lamellae. FIG. 6 shows a measurement of an anthropomorphic thorax phantom on a computed tomography device with an energy-integrating X-ray beam detector 1 which, in principle, has an anti-scatter grid 1 as described with reference to FIG. 2. FIG. 7 shows, by contrast, a measurement of the anthropomorphic thorax phantom on a computed tomography device with a photon-counting X-ray beam detector 1 which, in principle, has an anti-scatter grid 1 as described with reference to FIG. 3. The scanning parameters used are in both cases: 140 kV, 600 mA, slice thickness 5 mm, slice thickness increment 5 mm, matrix size 1024×1024. The images respectively show a field of view of 40 cm side length, a detail with a field of view of 4 cm is represented bottom right in an enlarged view respectively. It can be seen that a radio-frequency interfering signal (part rings) has been added in the case of the photon-counting X-ray beam detector 1. This interfering signal can be attributed to the configuration of the detector elements 11 relative to the anti-scatter grid 2. The scattered ray correction which was previously customary in the prior art does not correct this radio-frequency portion of the scattered radiation 32 resulting from the geometry of the anti-scatter grid 2. To prevent these artifacts, corresponding frequencies have therefore previously had to be suppressed in the image space, although this can be disadvantageous per se since signals can also be suppressed thereby. Due to the inventive scattered ray estimation, it is possible to prevent or correct such radio-frequency portions in the beginning already and frequencies no longer have to be suppressed in the image space. A very sharp reconstruction kernel can consequently also be used without greatly affecting a clinical diagnosis. Certain frequencies previously had to be suppressed in the image space in order to prevent these artifacts. Due to the correct correction of the scattered radiation in the beginning, frequencies no longer have to be suppressed and the clinical diagnosis is provided even when a sharp reconstruction kernel is used. For example (real) edges can consequently be represented much more clearly.

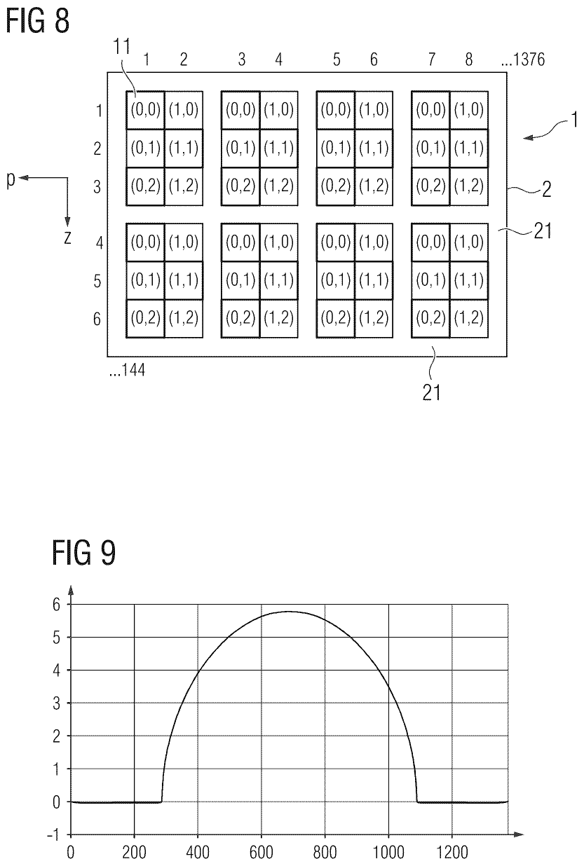

The method according to the exemplary embodiment in FIG. 1 will be explained below on the basis of FIGS. 8 to 16. An X-ray beam detector 1 as is shown in FIG. 8 is assumed in this case. Between the lamellae 21 of the anti-scatter grid 2 the X-ray beam detector 1 has six detector elements 11 respectively which, corresponding to their position relative to the anti-scatter grid, are designated by (0,0), (1, 0), (0,1), (1,1), (0,2), and (1,2). This corresponds to six different relative positions for the detector elements 11. Two respective detector elements 11 are between adjacent lamellae 21 in the phi-direction p and three respective detector elements 11 are between adjacent lamellae 21 in the z-direction z. In total the X-ray beam detector 1 has 1376 columns and 144 rows in this example, i.e. 1376 detector elements 11 in the phi-direction multiplied by 144 detector elements 11 in the z-direction. However, an X-ray beam detector 1 with a different number and/or division of detector elements 11 can be used.

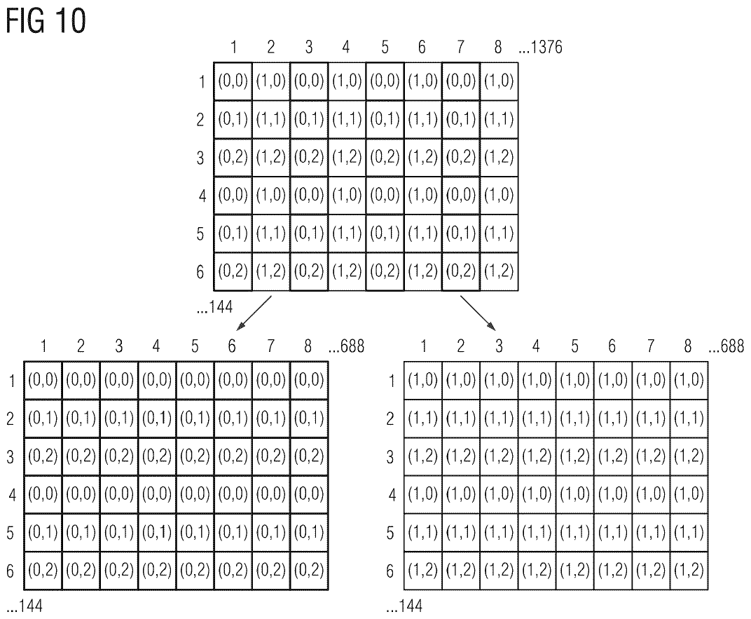

With reference to FIG. 1, detector data is received in a first method step 101. FIG. 9 shows, for example, detector data or here, by way of representation, a row (row 72 of 144 rows) of detector data, which has already been pre-processed here and transferred into the log space. The detector data can be described, for example, by p=−log (I/I0), substantially therefore as a logarithm of the standardized signal intensity. The data originates from a 30 cm water phantom which was positioned centrically in a computed tomography device. This detector data is divided into at least two groups of detector data. The division is based on the position of the detector elements 11, from which the detector data respectively originates, relative to the respective nearest lamella 21 of the anti-scatter grid 2. In the example shown here the detector data is divided into two groups, as is illustrated in FIG. 10. The detector data (0, Y), which originates from a detector element 11 directly to the right of a lamella 21, is divided into a first group (the left-hand group in FIG. 10) and the detector data (1, Y), which originates from a detector element 11 directly to the left of a lamella 21 is divided into a second group (the right-hand group in FIG. 10) respectively. The detector data is thus divided into two groups of detector data in such a way that the (in the illustration here) left-hand group originates from detector elements 11, which differ with regard to their position relative to the lamellae 21 in the phi-direction p from the detector elements 11 of the (in the illustration here) right-hand group. Two groups of data with 688 columns respectively resulted from data with 1376 columns. It would also be conceivable to undertake a division into more than two groups. In particular, a division in the z-direction z could additionally be provided. For example, six different groups could also result on the basis of the six different relative positions. The number of groups of detector data, into which the detector data is divided, would thereby correspond to the number of detector elements 11 between adjacent lamellae 21 respectively of the anti-scatter grid 2. However, the division into two groups is already clearly advantageous. The two groups will be designated here, for example, by p_{left} and p_{right}.

In a further step 102, a scattered ray distribution, which estimates a scattering on the basis of the detector data, is determined in the form of a scattered ray term for each of the groups of detector data. The scattered ray term can comprise a source term p_{source} which is based on a simplified scattered ray model of scattered ray sources, and a propagation term e^{-κ·p propagation}, which estimates a local photon scattering of the scattered rays. The scattered ray distribution pep can thus be calculated with a scattered ray term of the form

$$pep = {p}_{source ,} \cdot {e}^{- κ \cdot p propagation ,}$$

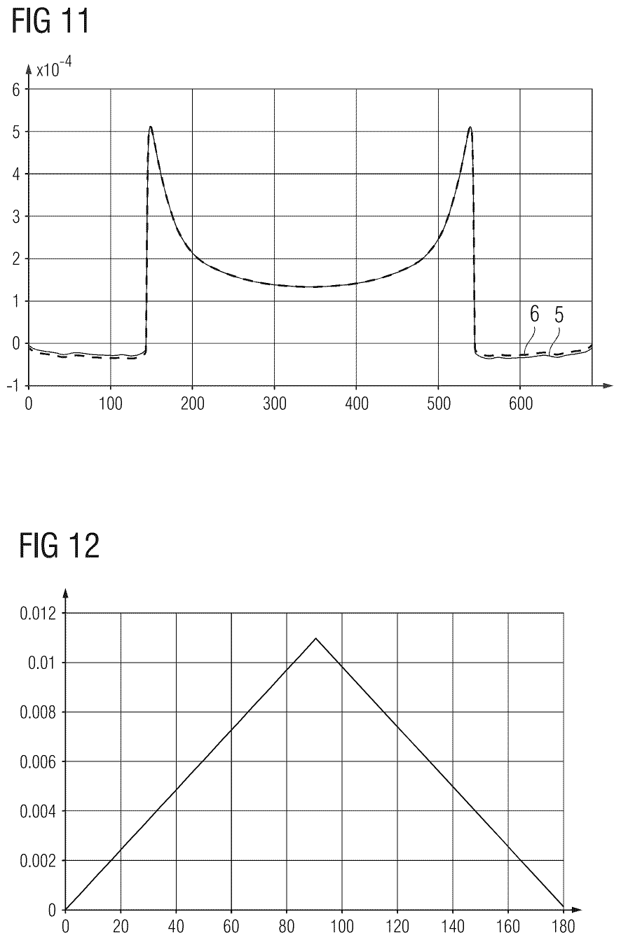

for each of the groups (pep_{left} 5 and pep_{right} 6) respectively by integration of all X-ray beams. FIG. 11 shows a corresponding scattered ray distribution for the two groups.

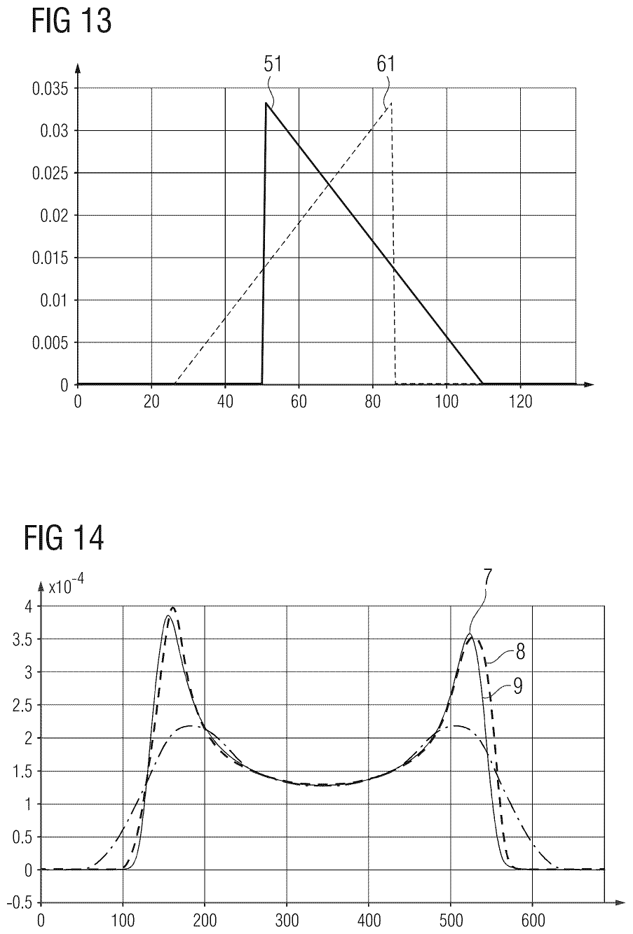

With reference again to FIG. 1, in a further step 103, the scattered ray term of each of the groups is convolved with one convolutional kernel individually adjusted respectively for each group, so a plurality of convolved scattered ray terms corresponding to the number of groups is generated. For comparison, FIG. 12 shows a standardized convolutional kernel for convolution in the phi-direction p according to the prior art. This is symmetrical and not specifically adjusted to the X-ray beam detector 1 in FIG. 8. According to the prior art, this convolutional kernel would be applied, moreover, to all of the data. FIG. 13, by contrast, shows two convolutional kernels 51, 61, according to one embodiment of the invention. One convolutional kernel 51 (h_{left}) is provided for the left-hand group according to FIG. 8 and the other convolutional kernel 61 (h_{right}) is provided for the right-hand group according to FIG. 8. The convolutional kernels 51, 61 are asymmetrical and adjusted to the relative position of the detector elements 11 relative to the lamellae. Correspondingly, pep_{left} is convolved with h_{left} and pep_{right} with h_{right}. The free model parameters of the convolutional kernels are adapted by way of a comparison with a Monte Carlo simulation. The convolution can take place (for left and right respectively) according to the following formula in order to obtain an estimated scattered ray intensity I_{S,right/left} for each of the groups (with the constants γ and κ):

$${I}_{S , right / left} = ( γ . {p}_{source , right / left} \cdot {e}^{- κ \cdot {p}_{p r o p a g a t ion , righ t / left}} ) * {h}_{r ight / left}$$

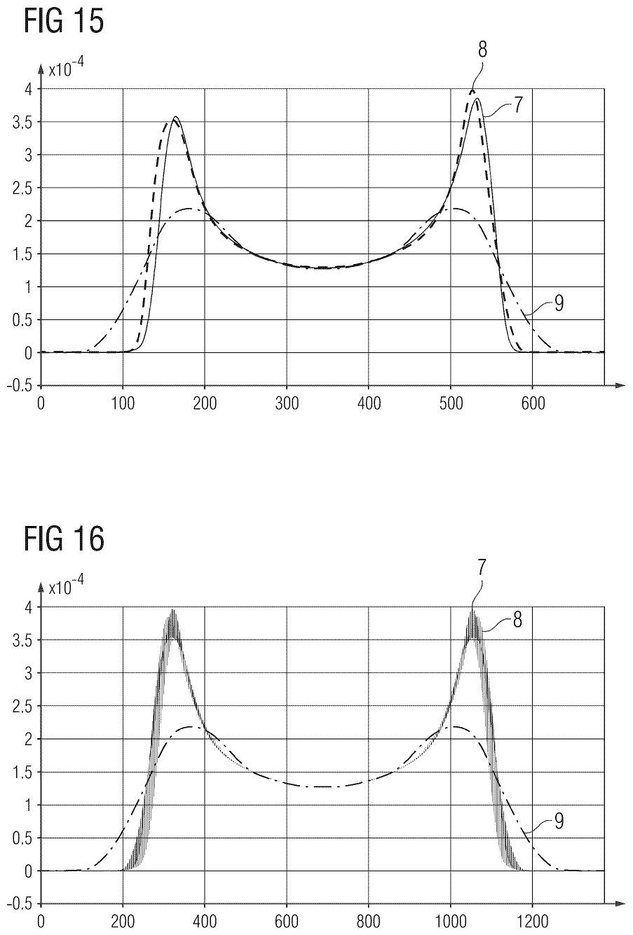

If there are more than two detector elements 11 (for example, six detector elements as in this case) between the lamellae 21 of the anti-scatter grid 2, more than two different convolutional kernels could also be applied (for example, six convolutional kernels corresponding to six groups). For example, first of all a convolution could take place in the phi-direction p and then in the z-direction z for each of the groups. FIG. 14 shows the resulting scattered ray distribution for the convolved scattered ray term 51 of the left-hand group and FIG. 15 for the convolved scattered ray term of the right-hand group. A (precise) Monte Carlo simulation 7, a scattered ray distribution 8 ascertained according to the inventive method as described here and a scattered ray distribution 9 ascertained according to the prior art with a single convolutional kernel as shown in FIG. 12 are shown respectively. It can be seen that the inventively convolved scattered ray terms 8 are located much closer to the (more or less exact, but more time-consuming) Monte Carlo simulation 7 than the scattered ray terms 9 estimated according to the prior art.

With reference again to FIG. 1, in a further step 104, the scattered ray distributions according to the convolved scattered ray terms are alternatingly merged corresponding to the position of the detector elements 11 in the X-ray beam detector 1. In this example, the detector pixels corresponding to the arrangement of the detector elements 11 in the X-ray beam detector 1 in FIG. 8 are consequently arranged on the horizontal axis. A scattered ray estimation is obtained thereby, as is shown according to the present example in FIG. 16. The scattered ray distribution 8, which was attained with the inventive method described here, together with a scattered ray distribution 7 according to a Monte Carlo simulation and a scattered ray distribution 9, which was created with a non-adjusted convolutional kernel, is again shown. The inventively determined scattered ray distribution 8 is much closer to the realistic scattered ray distribution 7 of the Monte Carlo simulation than the scattered ray distribution 9 according to the prior art. The radio-frequency portions of the scattered radiation are also taken into account with the scattered ray distribution 8 of the inventive method, and this is reflected in the radio-frequency oscillations of the scattered ray distribution 8. The scattered ray distribution 9 determined according to the prior art does not discernibly take these radio-frequency portions into account, by contrast. An improved scattered ray correction can thus be carried out with the inventive scattered ray estimation.

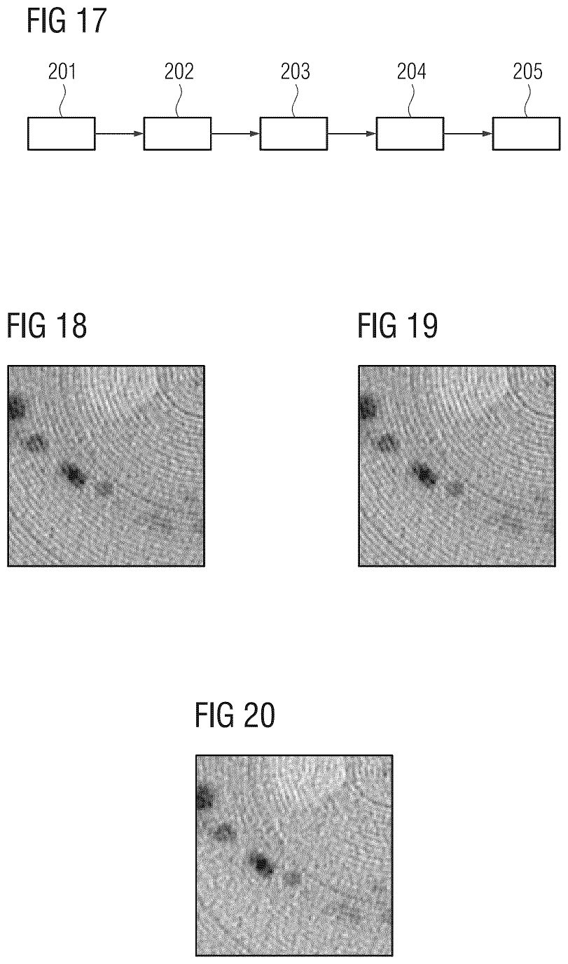

FIG. 17 shows a flowchart of a method for correcting scattered radiation effects in image data from an X-ray beam detector with a plurality of detector elements, with an anti-scatter grid 2 being arranged in front of the X-ray beam detector 1, with, in at least one direction, at least two respective detector elements being arranged between respective adjacent lamellae of the anti-scatter grid, according to one embodiment of the invention. Steps 201 to 204 correspond to steps 101 to 104 of the method described with reference to FIG. 1. In a further step 205, the image data is corrected on the basis of the ascertained scattered ray estimation. This takes place, in particular, in that the scattered ray estimation is offset by the input signal of the detector elements 11, for example, is subtracted from it. The effect of this correction can be understood, for example, from FIGS. 18 to 20. These Figures respectively show a recording of an anthropomorphic head phantom with a real cranial bone. No scattered ray correction was carried out in FIG. 18. The partial ring-shaped, radio-frequency portions of the scattered radiation (sharp ring artifacts) can be seen. In FIG. 19 a scattered ray correction according to the prior art was carried out with a non-adjusted convolutional kernel. The sharp ring artifacts can also still be seen virtually unchanged in the image detail shown in this figure. In FIG. 20, by contrast, the method according to the example as described herein was applied. It can be seen that the sharp ring artifacts are significantly attenuated.

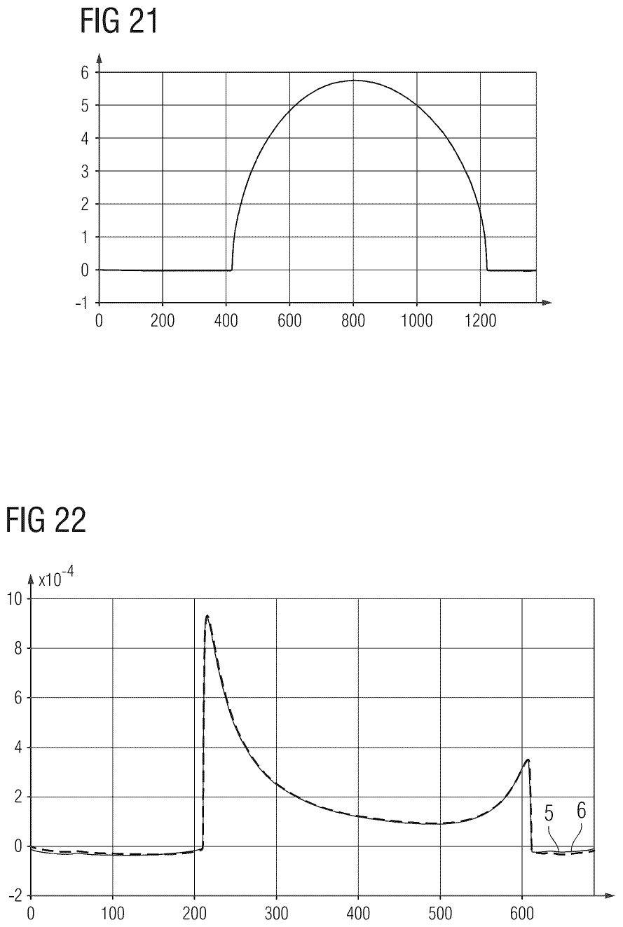

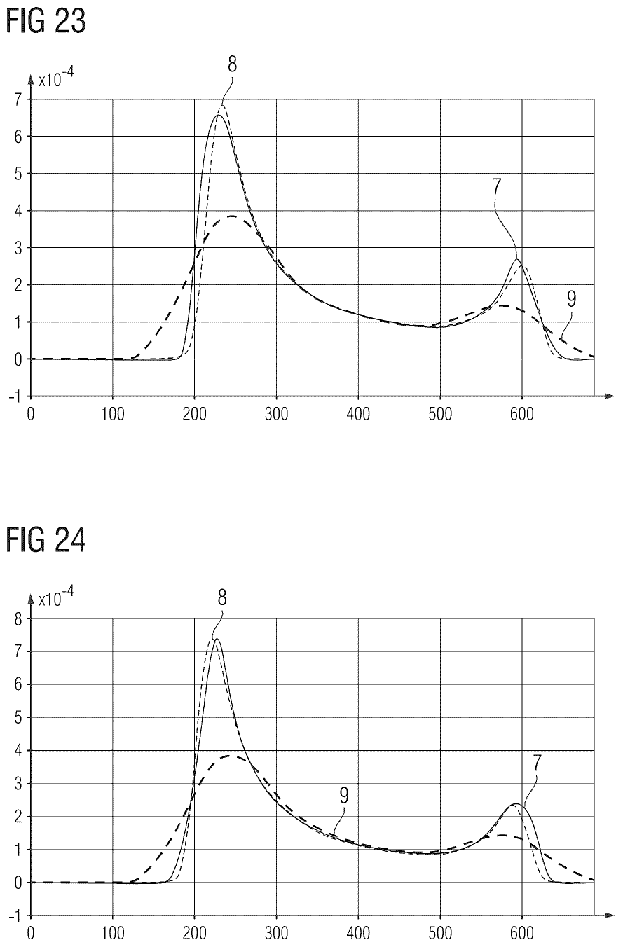

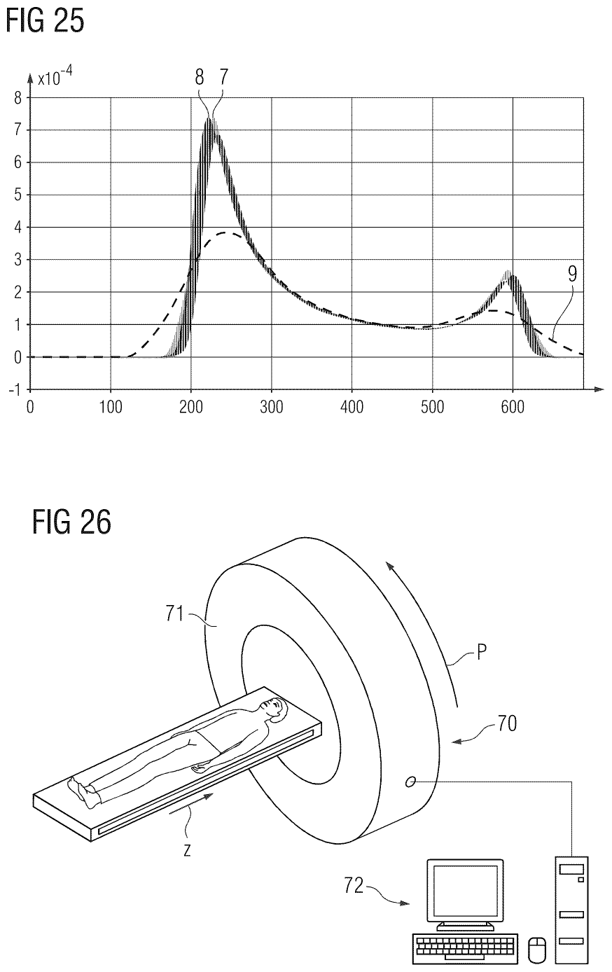

The inventive method can be flexibly applied to different situations. FIGS. 21 to 25 are shown as a further example of this. FIGS. 21 to 25 correspond to FIGS. 9, 11 and 14-16, with a 30 cm eccentric water phantom having been used this time instead of a central water phantom. Compared to FIG. 9, the detector data in FIG. 21 is therefore positioned slightly decentrally. A decentral arrangement of the scattered ray distribution according to the two scattered ray terms also results correspondingly in FIG. 22, which terms were determined from the divided detector data. The scattered ray distribution according to the convolved scattered ray terms is also correspondingly asymmetrical in FIGS. 23 (for the left-hand portion) and 24 (for the right-hand portion). Finally, FIG. 25 again shows the compiled scattered ray estimation. In FIGS. 23-25 the scattered ray distribution 8 determined with the inventive method on the basis of adjusted convolutional kernels is again significantly closer to the scattered ray distribution 7 of the Monte Carlo simulation than the scattered ray distribution 9 with a convolutional kernel which has not been adjusted. In addition, the radio-frequency portions of the scattered radiation in the inventively determined scattered ray distribution 8 can again be seen in FIG. 25.

FIG. 26 shows an imaging device, namely a computed tomography device 70, based on X-ray beams. The computed tomography device comprises a gantry 71 which in turn comprises an X-ray beam source and an X-ray beam detector 1 with a plurality of detector elements 11 as well as an anti-scatter grid 2 with lamellae 21. At least two respective detector elements 11 are arranged between respective adjacent lamellae 21 of the anti-scatter grid 2 in at least one direction of the anti-scatter grid 2. The X-ray beam detector 1 and the anti-scatter grid 2 can be embodied, for example, as shown in FIGS. 3 to 5 or FIG. 8. The computed tomography device 70 also comprises an evaluation apparatus 72 which is configured to receive detector data from the X-ray beam detector to execute an inventive method, for example the method as described in relation to FIG. 1 or FIG. 17. Also shown are the phi-direction p and the z-direction z of the computed tomography device 70.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors herein interpreted used accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for flash memory example devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

1. A computer-implemented method for determining a scattered radiation estimation for an X-ray beam detector with a plurality of detector elements, wherein an anti-scatter grid is in front of the X-ray beam detector, wherein in at least one direction, at least two respective detector elements are between respective adjacent lamellae of the anti-scatter grid, the method comprising:
receiving detector data and dividing the detector data into at least two groups of detector data based on a position of the detector elements, from which the detector data respectively originates, relative to a nearest respective lamella of the anti-scatter grid;
determining a scattered radiation distribution as a scattered radiation term for each of the groups of detector data, the scattered radiation distribution providing an estimate of a scattering based on the detector data;
convolving the scattered radiation term of each of the groups with a respective convolutional kernel individually adjusted for each group to generate a plurality of convolved scattered radiation terms corresponding to a number of the groups; and
merging the scattered radiation distributions according to the convolved scattered radiation terms to obtain the scattered radiation estimation.

2. The method of claim 1, wherein each scattered radiation term comprises a source term which is based on a scattered radiation model of scattered radiation sources, and a propagation term which estimates a local photon scattering of scattered radiation.

3. The method of claim 1, wherein at least one of the convolutional kernels is asymmetrically embodied.

4. The method of claim 1, wherein the number of groups of detector data corresponds to a number of detector elements between respective adjacent lamellae of the anti-scatter grid.

5. The method of claim 1, wherein the dividing divides the detector data into the groups of detector data such that at least one of the groups originates from detector elements which differ with regard to their position relative to the lamellae in a circumferential direction from detector elements of at least one other group.

6. The method of claim 1, wherein the dividing divides the detector data into the groups of detector data such that at least one of,
at least one of the groups originates from detector elements which differ with regard to a position relative to the lamellae in a circumferential direction from detector elements of at least one other group, or
at least one of the groups originates from detector elements which differ with regard to a position relative to the lamellae in an axial direction from detector elements of at least one other group.

7. The method of claim 1, wherein the convolutional kernels are adjusted respectively based on a precise simulation or a measurement of scattered radiation.

8. A method for correcting scattered radiation effects in image data from an X-ray beam detector with a plurality of detector elements, wherein an anti-scatter grid is in front of the X-ray beam detector, wherein in at least one direction, at least two respective detector elements are arranged between respective adjacent lamellae of the anti-scatter grid, wherein the method comprising:
performing the method for determining a scattered radiation estimation of claim 1; and
correcting the image data based on the scattered radiation estimation.

9. A non-transitory computer-readable storage medium, comprising commands which when executed by a computer of an X-ray beam detector cause the X-ray beam detector to execute the method of claim 1.

10. A medical imaging device comprising:
an X-ray beam source configured to generate X-ray beams;
an X-ray beam detector including a plurality of detector elements;
an anti-scatter grid including lamellae in front of the X-ray beam detector, wherein in at least one direction of the anti-scatter grid, at least two respective detector elements are between respective adjacent lamellae of the anti-scatter grid; and
an evaluation apparatus configured to receive detector data from the X-ray beam detector and to execute the method of claim 1.

11. The method of claim 3, wherein at least two of the convolutional kernels are asymmetrically embodied.

12. The method of claim 7, wherein the convolutional kernels are adjusted respectively based on a Monte Carlo simulation.

13. The method of claim 2, wherein at least one of the convolutional kernels is asymmetrically embodied.

14. The method of claim 13, wherein the number of groups of detector data corresponds to a number of detector elements between respective adjacent lamellae of the anti-scatter grid.

15. The method of claim 14, wherein the dividing divides the detector data into the groups of detector data such that at least one of the groups originates from detector elements which differ with regard to their position relative to the lamellae in a circumferential direction from detector elements of at least one other group.

16. The method of claim 14, wherein the dividing divides the detector data into the groups of detector data such that at least one of,
at least one of the groups originates from detector elements which differ with regard to a position relative to the lamellae in a circumferential direction from detector elements of at least one other group, or
at least one of the groups originates from detector elements which differ with regard to a position relative to the lamellae in an axial direction from detector elements of at least one other group.

17. The method of claim 16, wherein the convolutional kernels are adjusted respectively based on a precise simulation or a measurement of scattered radiation.
